(19) United States
(12) Patent Application Publication
(10) Pub. No.: US 2006/0109532 A1
(43) Pub. Date: May 25, 2006

(54) System and method for forming well-defined periodic patterns using achromatic interference lithography

(76) Inventors: Timothy A. Savas, Cambridge, MA (US); Henry I. Smith, Sudbury, MA (US)

Correspondence Address: GAUTHIER & CONNORS, LLP, 225 FRANKLIN STREET, BOSTON, MA, 02110, US

(21) Appl. No.: 10/993,529

(22) Filed: Nov. 19, 2004

(51) Int. Cl. G03H 1/10

(52) U.S. Cl. 359/10

(57) ABSTRACT

A beam, from a short-coherence-length source, is split and recombined by diffraction gratings not necessarily equal in spatial period. The recombining beams overlap and expose a common area on a substrate. The exposed area on the substrate is defined or shaped by at least one aperture in the beam paths. After exposure of one shaped area, relative translation between components permits exposure of another shaped area on the substrate. Additionally or alternatively, by introducing either rotation or translation between components during each exposure, the exposed area is made larger than the original shaped area.

### GOVERNMENT RIGHTS NOTICE

The present invention was made with US Government support under Grant (Contract) Number, DAAG55-98-1-0130, awarded by DARPA, and Grant (Contract) Number, DMR-9871539, awarded by NSF. The US Government has certain rights to this invention.

### FIELD OF THE PRESENT INVENTION

The present invention relates to achromatic interference lithography for providing an interference pattern in a resist and, in particular, to provide an interference pattern in a resist so that the resist is exposed to form a well-defined periodic pattern therein.

### BACKGROUND OF THE PRESENT INVENTION

Conventionally, grating images have been produced by first splitting light from a highly coherent source into a plurality of light beams and then recombining the split beams. In these conventional systems, the light source must be temporally and spatially coherent to produce large-area grating images.

The simplest embodiment of this type of interference lithography is shown in FIG. 14. As illustrated in FIG. 14, a light 200 from a highly coherent source (not shown) is split into two or more beams by beam splitter 100. The split beams are incident upon mirrors 110 and 120 and are reflected towards a resist-coated substrate 130. The reflected light beams are recombined to form an interference region 140 upon the resist-coated substrate 130.

Another conventional process or system of forming grating images is near-field lithography. FIGS. 15 and 16 illustrate two types of conventional near-field lithography. More specifically, FIG. 15 illustrates a near-field lithography or near-field holography system having a spatial-period division, and FIG. 16 illustrates a near-field lithography system having a period duplication. In each of these systems, a single grating is used to split the incident beam. Since the beam is split with a grating, the technique is also referred as achromatic, that is, the contrast in the interference pattern does not depend on the temporal coherence of the source.

As illustrated in FIG. 15, a light beam 300 from a coherent light source (not shown) is incident upon a substrate 310, at an angle normal to the surface of the substrate 310. The substrate 310 has a phase grating 320 thereon with the period of the phase or master grating 320 being P. The phase grating 320 splits the incident light beam 300 into two beams having different orders (−1 and +1). The two beams are incident upon a near resist-coated substrate 330 and form an interference pattern region 340. The interference pattern has a period of P/2. The resist-coated substrate 330 must be brought into close proximity to the master grating 320 so that the beams overlap on the substrate's surface to form the interference pattern 340. In this system, the zero-order beam is suppressed so that the grating image has half the period of the master grating 320.

As illustrated in FIG. 16, a light beam 400 from a coherent light source (not shown) is incident upon a substrate 410, at an angle not normal to the surface of the substrate 410. The substrate 410 has a phase or master grating 420 thereon with the period of the phase grating 420 being P. The phase grating 420 splits the incident light beam 400 into two beams having different orders (−1 and 0). The two beams are incident upon a near resist-coated substrate 430 and form an interference pattern region 440. The interference pattern has a period of P. The resist-coated substrate 430 must be brought into close proximity to the master grating 420 so that the beams overlap on the substrate's surface to form the interference pattern 440. In this system, the source has twice the wavelength of that in FIG. 15, so that the resulting interference pattern 440 has the same period as the master grating 420.

The near-field technique, illustrated in FIGS. 15 and 16, is commonly used in industry; however, this technique suffers from a few problems. First, any defects in, or particles on, the master grating get “printed” on the resist-coated substrate. Secondly, there are many reflections (beams bouncing between the master grating and the substrate) that degrade the image quality. Third, the technique is usually done with a coherent source, but if done with an incoherent source, the depth of focus is very small.

A way to circumvent the difficulties associated with lithography in the near field is to use an achromatic technique that uses two gratings, as illustrated in FIG. 17. This technique, “Achromatic Interference Lithography” (AIL), produces twice the depth of focus as compared to the near-field technique and the substrate is placed in the far field so that small defects and particles do not appear in the grating image.

As illustrated in FIG. 17, a light beam 500 from a light source (not shown) is incident upon a substrate 510, at some angle to the surface of the substrate 510. The substrate 510 has a phase grating thereon with the period of the phase grating being P. The phase grating substrate 510 splits the incident light beam 500 into beams having different orders. Beams, from the phase grating substrate 510, that are incident upon a second phase grating substrate 520 are split into additional beams having different orders. Beams from the second phase grating substrate 520 are incident upon a substrate 530 having a resist layer 540 thereon. The beams from the second phase grating substrate 520 form an interference pattern region 550. The interference pattern has a period of P/2.

Although achromatic interference lithography overcomes some of the disadvantages of the other interference lithography methods, achromatic interference lithography cannot be readily modified so that the size of the exposed area increases. It has been a desirable advantage in the interference lithography art to have large exposure areas so as to fill a wafer with the desired structures, thereby reducing manufacturing costs associated with the wafer and the components thereon. In other words, the more area of the wafer is utilized in constructing components, the lower the manufacturing costs thereof.

Therefore, it is desirable to provide a system that captures the advantages of achromatic interference lithography, but also realizes the reduction in manufacturing costs by maximizing the effective area of the wafer being processed. Moreover, it is desirable to provide a system wherein the size of the exposure area can be sharply delineated and the area of the wafer being processed is maximized.

### SUMMARY OF THE PRESENT INVENTION

A first aspect of the present invention is a method of lithographically exposing a substrate to form a well-defined periodic pattern thereupon. The method provides a source of incoherent light; shapes the incoherent light with an optical shaping device; splits the shaped light into a plurality of beams, each beam being of a different order; and splits the split beams into a plurality of beams, each beam being of a different order, the re-split different order beams being allowed to propagate to the substrate to produce an interference pattern upon the substrate.

A second aspect of the present invention is a method of lithographically exposing a substrate to form a well-defined periodic pattern thereupon. The method provides a source of incoherent light; splits the incoherent light into a plurality of beams, each beam being of a different order; shapes the split light beams with an optical shaping device; and splits the shaped beams into a plurality of beams, each beam being of a different order, the re-split beams being allowed to propagate to the substrate to produce an interference pattern upon the substrate.

A third aspect of the present invention is a method of lithographically exposing a substrate to form a well-defined periodic pattern thereupon. The method provides a source of incoherent light; splits the incoherent light into a plurality of beams, each beam being of a different order; splits the split beams into a plurality of beams, each beam being of a different order; and shapes the re-split light with an optical shaping device, the shaped beams being allowed to propagate to the substrate to produce an interference pattern upon the substrate.

A fourth aspect of the present invention is a system for exposing a substrate to form a well-defined periodic pattern thereupon. The system includes a source of incoherent light; an optical shaping device to shape the incoherent light; a first beam splitter to split the shaped light into a plurality of beams, each beam being of a different order; and a second beam splitter to split the split beams into a plurality of beams, each beam being of a different order, the second beam splitter allowing the re-split beams to propagate to the substrate to produce an interference pattern upon the substrate.

A fifth aspect of the present invention is a system for exposing a substrate to form a well-defined periodic pattern thereupon. The system includes a source of incoherent light; a first beam splitter to split the incoherent light into a plurality of beams, each beam being of a different order; an optical shaping device to shape the split light; and a second beam splitter to split the shaped beams into a plurality of beams, each beam being of a different order, the second beam splitter allowing the re-split beams to propagate to the substrate to produce an interference pattern upon the substrate.

A sixth aspect of the present invention is a system for exposing a substrate to form a well-defined periodic pattern thereupon. The system includes a source of incoherent light; a first beam splitter to split the incoherent light into a plurality of beams, each beam being of a different order; a second beam splitter to split the split beams into a plurality of beams, each beam being of a different order; and an optical shaping device to shape the re-split light, the shaped beams being allowed to propagate to the substrate to produce an interference pattern upon the substrate.

### BRIEF DESCRIPTION OF THE DRAWINGS

The present invention may take form in various components and arrangements of components, and in various steps and arrangements of steps. The drawings are only for purposes of illustrating a preferred embodiment and are not to be construed as limiting the present invention, wherein:

FIG. 1 is a schematic representation of an achromatic interference lithography system using transmission gratings according to the concepts of the present invention;

FIG. 2 is a schematic representation of an achromatic interference lithography system using transmission and reflection gratings and mirrors according to the concepts of the present invention;

FIG. 3 is a schematic representation of an achromatic interference lithography system using reflection gratings where the incident beam is out of plane according to the concepts of the present invention;

FIGS. 4 and 5 are schematic representations of achromatic interference lithography systems using reflection and transmission gratings where the incident beam is out of plane according to the concepts of the present invention;

FIG. 6 is a schematic representation of an achromatic interference lithography system using reflection gratings and mirrors where the incident beam is out of plane according to the concepts of the present invention;

FIG. 7 is a schematic representation of an achromatic interference lithography system using transmission gratings and grids according to the concepts of the present invention;

FIGS. 8 and 9 show top views of the substrate and the aperture used to shape the beams according to the concepts of the present invention;

FIGS. 10 and 11 show top views of the substrate and the aperture used to shape the beams according to the concepts of the present invention;

FIGS. 12 and 13 show top views of the substrate and the aperture used to shape the beams in a rotary configuration according to the concepts of the present invention;

FIG. 14 is a schematic representation of a conventional interference lithography system;

FIGS. 15 and 16 are schematic representations of conventional near-field lithography systems; and

FIG. 17 is a schematic representation of a conventional achromatic interference lithography system.

### DETAIL DESCRIPTION OF THE PRESENT INVENTION

The present invention will be described in connection with preferred embodiments; however, it will be understood that there is no intent to limit the present invention to the embodiments described herein. On the contrary, the intent is to cover all alternatives, modifications, and equivalents as may be included within the spirit and scope of the present invention, as defined by the appended claims.

For a general understanding of the present invention, reference is made to the drawings. In the drawings, like reference have been used throughout to designate identical or equivalent elements. It is also noted that the various drawings illustrating the present invention are not drawn to scale and that certain regions have been purposely drawn disproportionately so that the features and concepts of the present invention could be properly illustrated.

As noted above, it is desirable to provide a system wherein the size of the exposure area can be sharply delineated and the area of the wafer being processed is maximized. The present invention realizes this utilizing achromatic interference lithography to enable the size of the exposure area to be sharply delineated, but instead of utilizing the conventional methodology of filling a wafer with a single exposure, the present invention fills the wafer with multiple exposures. In other words, the present invention, in lieu of increasing the exposure area of achromatic interference lithography so that a wafer is covered by a single exposure, incrementally relatively translates or rotates the substrate with respect to the achromatic interference lithography generated interference pattern so as to fill the entire wafer with the desired structures or components.

The present invention relates, in general, to interference lithography (sometimes termed “holographic” lithography) and in particular to one implementation of interference lithography termed “achromatic interference lithography.” In interference lithography, a periodic pattern is created by overlapping two beams from a laser or other coherent source. The contrast in the periodic pattern is a function of the degree of temporal and spatial coherence in the source. The minimal spatial period, p, (that is, the center-to-center distance between adjacent lines) obtainable in interference lithography is given by p=λ/2 sin θ where λ is the source wavelength and θ is the half angle between the overlapping beams.

As noted above, although interference lithography is a means for producing large-area gratings and grids, the conventional technique suffers from the inability to adequately shape the overlapping beams and thus shape the interference area. Scattering from apertures placed in the beam paths interfere coherently with the overlapping beams to produce deleterious results in the exposed area.

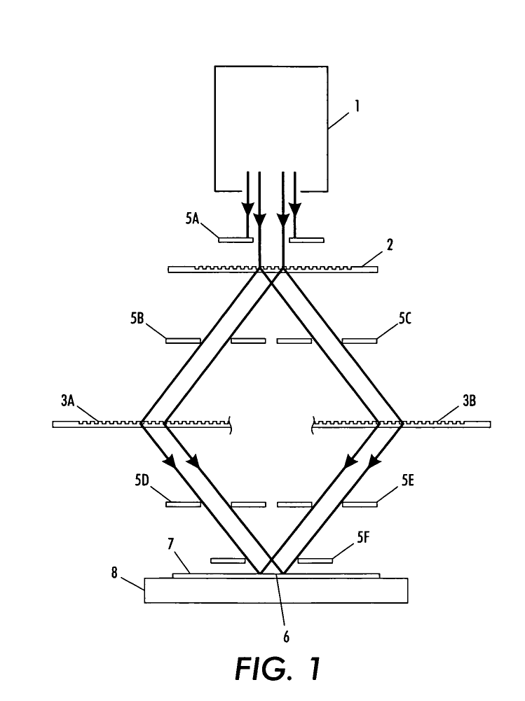

The present invention provides a system and method that circumvents difficulties encountered by conventional interference lithography, which uses highly coherent sources. One such embodiment is illustrated in FIG. 1.

As illustrated in FIG. 1, achromatic interference lithography is implemented. A light source 1, consisting of photons, atoms, or molecules, emits a beam that is incident at any angle upon diffraction grating 2. Any two diffracted orders from grating 2 are selected and allowed to propagate to gratings 3a and 3b. All other diffracted orders are not shown and the means of selection, for example, beam blocks, are not shown.

Gratings 3a and 3b may be physically separated from one another or attached to the same substrate. Gratings 3a and 3b then rediffract the two incident beams and two rediffracted beams are again selected and allowed to propagate to an interference region 6.

In region 6, the two selected beams interfere to produce a grating image of period p, p being equal to or some fraction of the periods of gratings 2, 3a, and 3b, which may be equal or different in period to one another.

Since the implementation of the present invention, as illustrated in FIG. 1, is achromatic, the light source 1 may possess a large spread in wavelength. In other words, the light source 1 may have a short coherence length.

According to the concepts of the present invention, hard-edged or apodized apertures, 5a-5f, as shown in FIG. 1, may be inserted at any point along the beam path provided the distance from apertures, 5a-5f, to the interference region 6 is larger than the coherence length of the light source 1. That is, any radiation or particles scattering from the apertures, 5a-5f, will not interfere coherently with the beams selected to interfere in region 6. Therefore, no deleterious defects will be produced in the images in region 6 by the introduction of apertures, 5a-5f, if apertures, 5a-5f, are placed sufficiently distant from interference region 6.

By utilizing the apertures, 5a-5f, the present invention realizes the advantage of the interfering beams, and thus the interference region 6, will have a shape determined by any or all apertures, 5a-5f. Since apertures, 5a-5f, may be of any size and shape, the region 6 may be of any size or shape.

As illustrated in FIG. 1, a resist-coated substrate 7, mounted on a movable stage 8, may be exposed with a periodic pattern within a well-defined region by placing the resist-coated substrate 7, mounted on movable stage 8, within the overlap region 6. With no relative motion between system components during exposure, the region of exposure is then limited to the shape of the interference region 6 at the resist-coated substrate 7, mounted on movable stage 8, defined by apertures, 5a-5f.

In this embodiment, the diffraction gratings have equal spatial periods, P. In this case, the beam is diffracted by the first grating 2, the “splitter” grating, into zero-, first-order, and possibly higher-order beams. The beams are allowed to propagate to the second grating (3a and 3b), the “re-combiner” grating. At the second grating (3a and 3b), the beams are again diffracted into different orders.

Some diffracted orders are allowed to propagate and overlap a common area 6 on the resist surface 7 of substrate 8. The overlapping beams produce an interference pattern whose periodicity, p, is equal to, or is some fraction, of P. With this technique, source temporal and spatial coherences do not affect the contrast in the interference pattern. Spatial incoherence limits only the depth of focus, that is, the range of distances within which the substrate must be placed to achieve high contrast.

The interference technique of the present invention is not limited to the configuration shown in FIG. 1, but can be implemented by using reflection gratings in place of transmission gratings and by introducing mirrors into the beam paths.

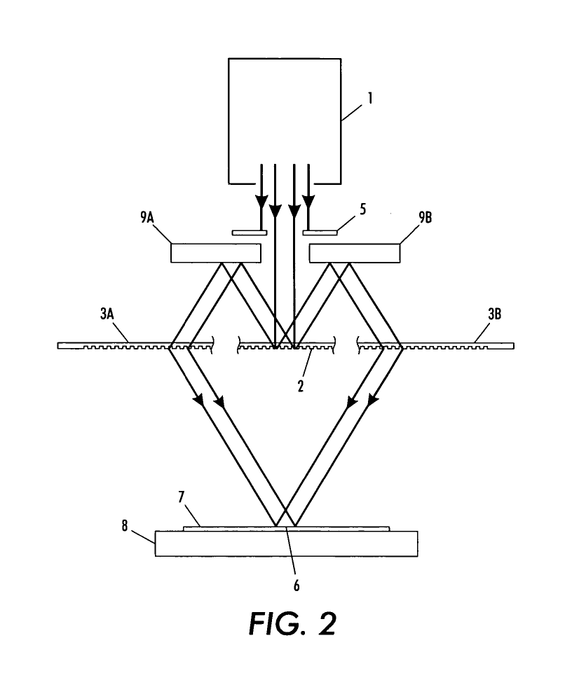

For example, FIG. 2 shows another embodiment of the present invention wherein mirrors 9a and 9b are introduced so that grating 2 is a reflection grating and gratings 3a and 3b are transmission gratings. As shown in FIG. 2, gratings 2, 3a, and 3b are planar to one another and may or may not be attached to the same substrate.

FIG. 2 also shows the use of an aperture 5 that shapes the beam as it exits the light source 1. Although not illustrated, the embodiment of FIG. 2, according to the concepts of the present invention, may include multiple apertures along the beam path, as shown in FIG. 1, to provide further shaping.

As illustrated in FIG. 2, a resist-coated substrate 7, mounted on a movable stage 8, may be exposed with a periodic pattern within a well-defined region by placing the resist-coated substrate 7, mounted on movable stage 8, within the overlap region 6. With no relative motion between system components during exposure, the region of exposure is then limited to the shape of the interference region 6 at the resist-coated substrate 7, mounted on movable stage 8, defined by aperture 5 or apertures.

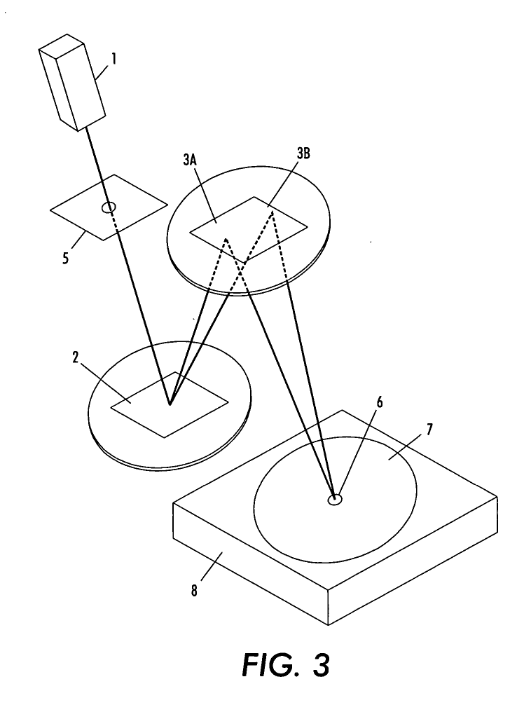

FIG. 3 shows another embodiment of the present invention wherein all transmission gratings of FIG. 1 have been replaced entirely by reflection gratings 2, 3a, and 3b.

FIG. 3 also shows the use of an aperture 5 that shapes the beam as it exits the light source 1. Although not illustrated, the embodiment of FIG. 3, according to the concepts of the present invention, may include multiple apertures along the beam path, as shown in FIG. 1, to provide further shaping.

As illustrated in FIG. 3, a resist-coated substrate 7, mounted on a movable stage 8, may be exposed with a periodic pattern within a well-defined region by placing the resist-coated substrate 7, mounted on movable stage 8, within the overlap region 6. With no relative motion between system components during exposure, the region of exposure is then limited to the shape of the interference region 6 at the resist-coated substrate 7, mounted on movable stage 8, defined by aperture 5 or apertures.

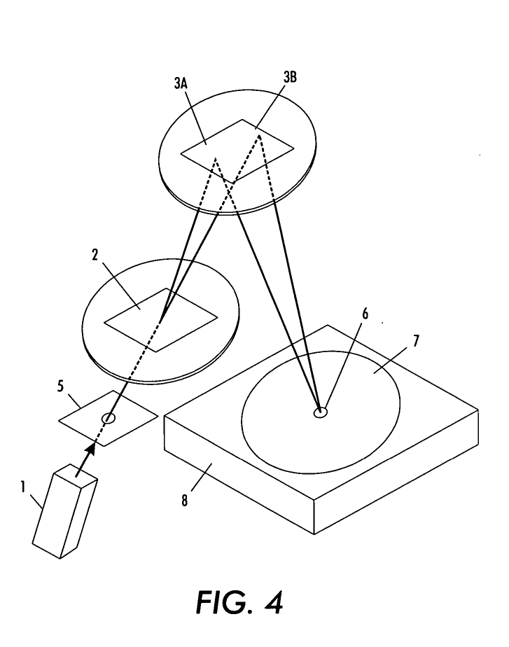

FIGS. 4 and 5 show embodiments of the present invention wherein gratings 2, 3a, and 3b are some combination of transmission and reflection gratings.

FIGS. 4 and 5 also show the use of an aperture 5 that shapes the beam as it exits the light source 1. Although not illustrated, the embodiments of FIGS. 4 and 5, according to the concepts of the present invention, may include multiple apertures along the beam path, as shown in FIG. 1, to provide further shaping.

As illustrated in FIGS. 4 and 5, a resist-coated substrate 7, mounted on a movable stage 8, may be exposed with a periodic pattern within a well-defined region by placing the resist-coated substrate 7, mounted on movable stage 8, within the overlap region 6. With no relative motion between system components during exposure, the region of exposure is then limited to the shape of the interference region 6 at the resist-coated substrate 7, mounted on movable stage 8, defined by aperture 5 or apertures.

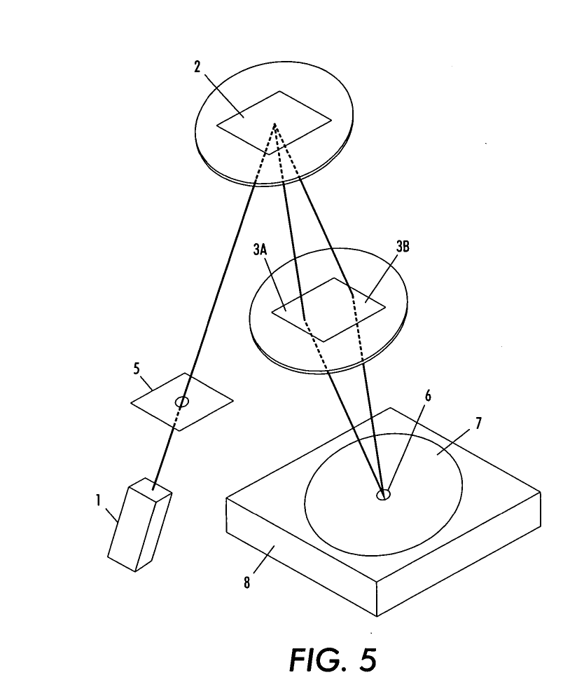

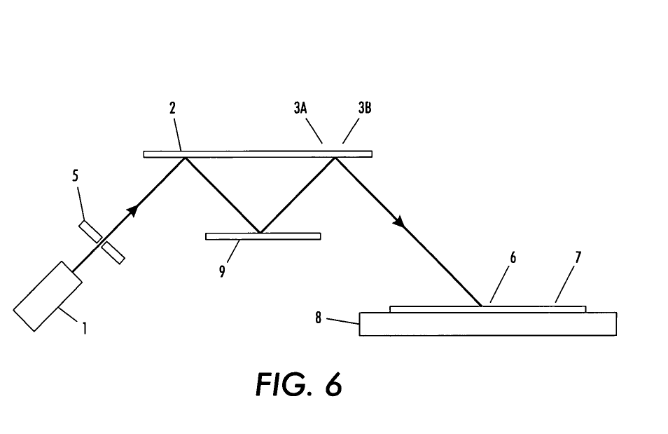

FIG. 6 shows another embodiment (side view) of the present invention wherein a mirror 9 has been introduced so that gratings 2, 3a, and 3b are planar to one another and may or may not be attached to the same substrate.

FIG. 6 also shows the use of an aperture 5 that shapes the beam as it exits the light source 1. Although not illustrated, the embodiment of FIG. 6, according to the concepts of the present invention, may include multiple apertures along the beam path, as shown in FIG. 1, to provide further shaping.

As illustrated in FIG. 6, a resist-coated substrate 7, mounted on a movable stage 8, may be exposed with a periodic pattern within a well-defined region by placing the resist-coated substrate 7, mounted on movable stage 8, within the overlap region 6. With no relative motion between system components during exposure, the region of exposure is then limited to the shape of the interference region 6 at the resist-coated substrate 7, mounted on movable stage 8, defined by aperture 5 or apertures.

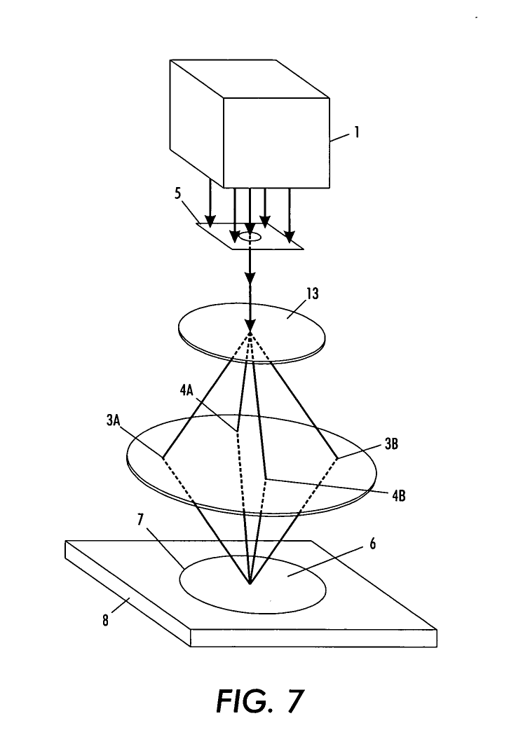

The achromatic interference technique of the present invention is not limited to producing a grating image, but may also be configured so that a grid image (two or more overlapping grating images) is formed in the interference region 6 as shown in FIG. 7.

As shown in FIG. 7, the beam from light source 1 may be incident upon a grid 13. Any four diffracted orders of the light beam from grid 13 may be selected and allowed to propagate to gratings 3a, 3b, 4a, and 4b where the light beams are again diffracted. Four rediffracted beams from gratings 3a, 3b, 4a, and 4b may then be selected and allowed to propagate to interference region 6 where they interfere to produce a grid image. The grid image in this case consists of two overlapping grating images of periods P₁ and P₂ where P₁ and P₂ may or may not be equal to one another.

FIG. 7 also shows the use of an aperture 5 that shapes the beam as it exits the light source 1. Although not illustrated, the embodiment of FIG. 7, according to the concepts of the present invention, may include multiple apertures along the beam path, as shown in FIG. 1, to provide further shaping.

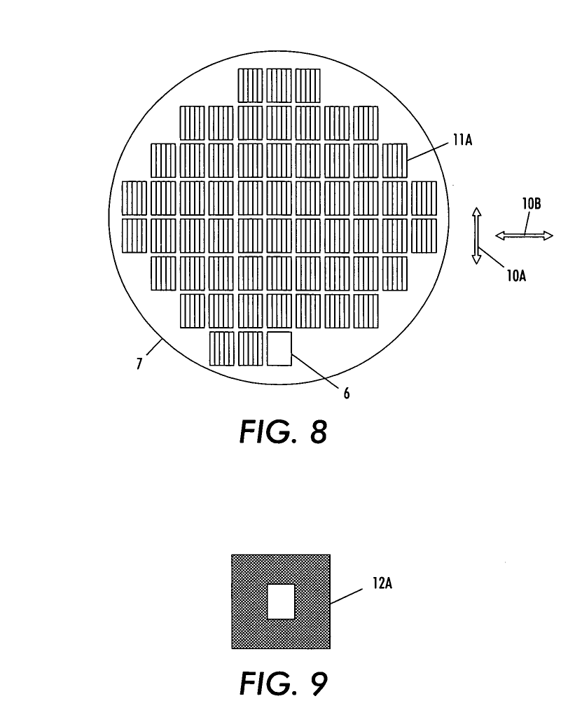

According to the concepts of the present invention, as shown in FIG. 8, after exposing one well-defined region 11 a, the resist-coated substrate 7, mounted on a movable stage (not shown in FIG. 8 but shown as reference 8 in FIGS. 1, 2, 3, 4, 5, 6, and 7), may be translated or “stepped” along directions 10a and 10b so that a new separate region 6, defined by aperture 12a, as shown in FIG. 9, may be exposed. By introducing relative motion between the substrate and interferometer (including any apertures) along directions 10a and 10b in between exposures, more than one well-defined region may be patterned on a singe substrate.

It is noted that either the stage itself may be translated or rotated in relation to the interferometer or the actual light beam and the apertures may be deflected to provide the relative motion between the resist-coated substrate and the interference pattern.

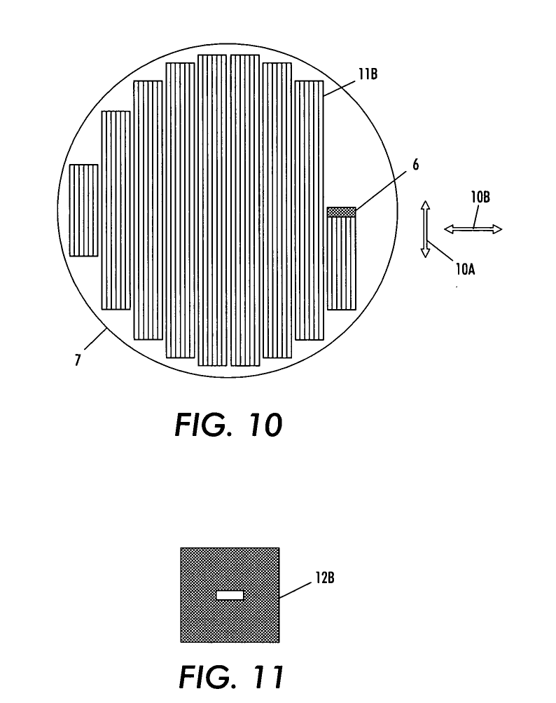

As shown in FIG. 10, relative motion, between the resist-coated substrate 7 and interferometer (including any apertures) along direction 10a (along a line parallel to the grating-image lines) during exposure will result in a single well-defined exposure area 11b that is larger than the interference area 6 defined by aperture 12b, as shown in FIG. 11. The resulting region 11b is filled with parallel lines and spaces. By introducing relative motion along direction 10b between resist-coated substrate 7 and the interferometer in between exposures, more than one elongated well-defined region 11b may patterned on a single substrate, as indicated in FIG. 10.

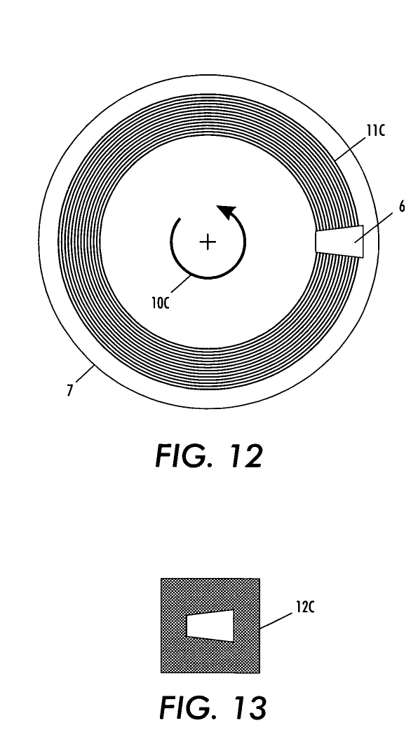

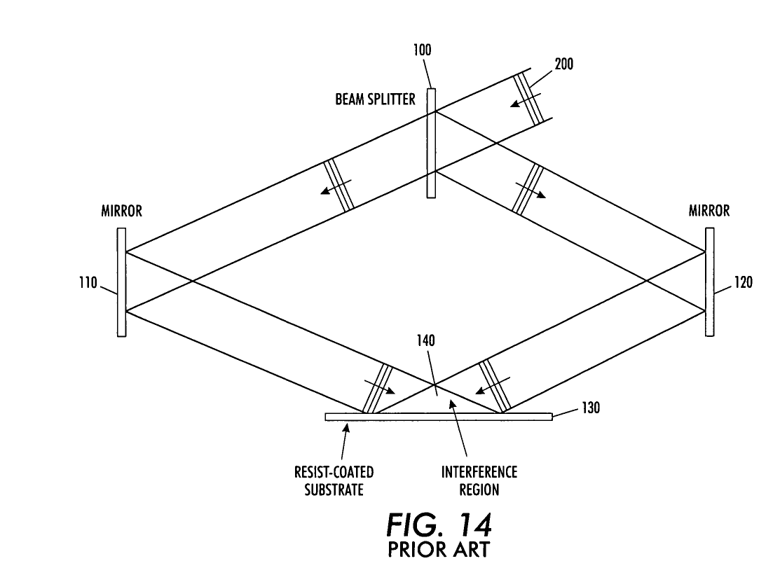

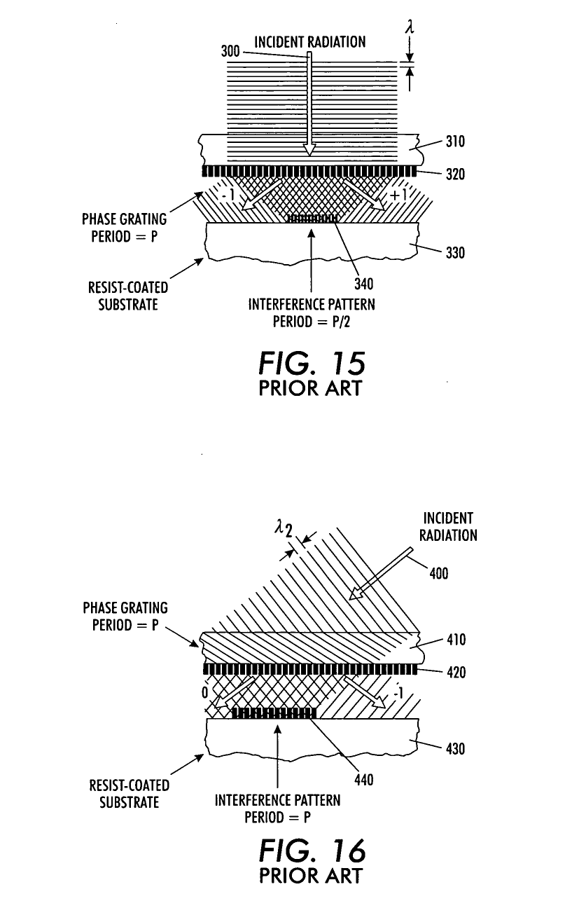

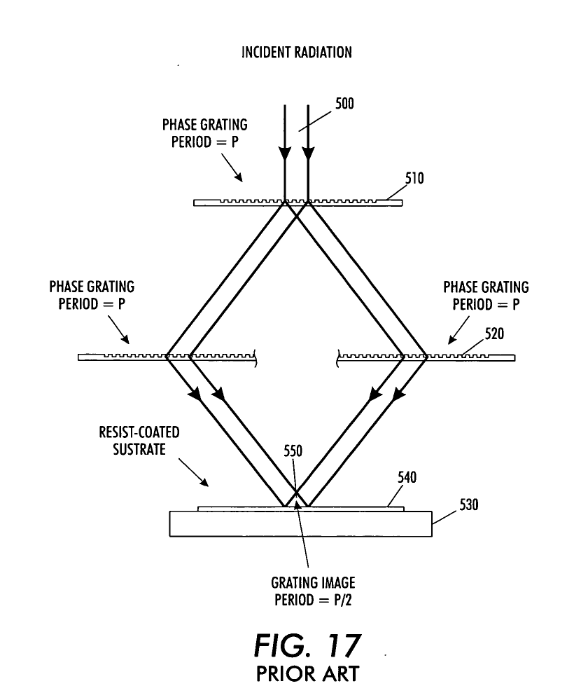

As shown in FIG. 12, introducing rotation 10c between resist-coated substrate 7 and interferometer components during exposure will result in a pattern whose area is larger than the interference region 6 defined by aperture 12c, as shown in FIG. 13. The resulting pattern on resist-coated substrate 7 then consists of concentric circles.

As demonstrated above, the present invention provides means for producing a well-defined periodically patterned region at some plane in space and producing more than one such well-defined region on a single substrate, each of which is filled with a periodic pattern. Each region on the substrate is similar in area and shape to that of the well-defined region in space. Such a technique, termed “step and repeat,” can be employed in a manufacturing environment to greatly reduce cost and increase throughput.

Moreover, as demonstrated above, the present invention provides means for producing one or more well-defined regions on a single substrate, where the size of each well-defined region on the substrate is larger than the original well-defined region in space. Additionally, the periodic pattern on the substrate may be different than the pattern in space.

The present invention recognizes that a beam from an incoherent source (consisting of photons, atoms, or molecules) may be shaped by apertures, and the radiation or particles scattered from the apertures will not interfere coherently with the shaped beam at some point beyond the aperture. Therefore, such scattered beams will not produce deleterious defects in the periodic pattern formed by the shaped overlapping beams.

According to the concepts of the present invention, the achromatic interferometer in conjunction with beam shaping methods allows the production of a well-defined periodically patterned region in space. Furthermore, the introduction of relative motion between system components allows for patterning one or more shaped regions on a single substrate and for patterning one or more regions on a substrate, each of which is larger than the original region in space.

In summary, a beam, from a short-coherence-length source, is split and recombined by diffraction gratings not necessarily equal in spatial period. The recombining beams overlap and expose a common area on a substrate. The exposed area on the substrate is defined or shaped by at least one aperture in the beam paths. After exposure of one shaped area, relative translation between components permits exposure of another shaped area on the substrate. Additionally or alternatively, by introducing either rotation or translation between components during each exposure, the exposed area is made larger than the original shaped area.

While various examples and embodiments of the present invention have been shown and described, it will be appreciated by those skilled in the art that the spirit and scope of the present invention are not limited to the specific description and drawings herein, but extend to various modifications and changes.

What is claimed is:

1. A method of lithographically exposing a substrate to form a well-defined periodic pattern thereupon, comprising:
(a) providing a source of incoherent light;
(b) shaping the incoherent light with an optical shaping device;
(c) splitting the shaped light into a plurality of beams, each beam being of a different order; and
(d) splitting the split beams into a plurality of beams, each beam being of a different order, the re-split different order beams being allowed to propagate to the substrate to produce an interference pattern upon the substrate.

2. The method as claimed in claim 1, further comprising:
(e) relatively translating the substrate with respect to the interference pattern after patterning a well-defined area of the substrate; and
(f) repeating steps (a) through (d) to expose another area of the substrate to form a well-defined periodic pattern thereupon.

3. The method as claimed in claim 1, further comprising:
(e) relatively rotating the substrate with respect to the interference pattern during the execution of steps (a) through (d) to produce concentric circles upon the substrate.

4. The method as claimed in claim 1, further comprising:
(e) relatively translating the substrate with respect to the interference pattern during the execution of steps (a) through (d) to produce a larger area having a well-defined periodic pattern therein.

5. The method as claimed in claim 1, wherein the light is split using transmission diffraction gratings.

6. The method as claimed in claim 1, wherein the light is split using reflection diffraction gratings.

7. The method as claimed in claim 1, wherein the light is split using reflection diffraction gratings and transmission diffraction gratings.

8. A method of lithographically exposing a substrate to form a well-defined periodic pattern thereupon, comprising:
(a) providing a source of incoherent light;
(b) splitting the incoherent light into a plurality of beams, each beam being of a different order;
(c) shaping the split light beams with an optical shaping device; and
(d) splitting the shaped beams into a plurality of beams, each beam being of a different order, the re-split beams being allowed to propagate to the substrate to produce an interference pattern upon the substrate.

9. The method as claimed in claim 8, further comprising:
(e) relatively translating the substrate with respect to the interference pattern after patterning a well-defined area of the substrate; and
(f) repeating steps (a) through (d) to expose another area of the substrate to form a well-defined periodic pattern thereupon.

10. The method as claimed in claim 8, further comprising:
(e) relatively rotating the substrate with respect to the interference pattern during the execution of steps (a) through (d) to produce concentric circles upon the substrate.

11. The method as claimed in claim 8, further comprising:
(e) relatively translating the substrate with respect to the interference pattern during the execution of steps (a) through (d) to produce a larger area having a well-defined periodic pattern therein.

12. The method as claimed in claim 8, wherein the light is split using transmission diffraction gratings.

13. The method as claimed in claim 8, wherein the light is split using reflection diffraction gratings.

14. The method as claimed in claim 8, wherein the light is split using reflection diffraction gratings and transmission diffraction gratings.

15. A method of lithographically exposing a substrate to form a well-defined periodic pattern thereupon, comprising:
(a) providing a source of incoherent light;
(b) splitting the incoherent light into a plurality of beams, each beam being of a different order;
(c) splitting the split beams into a plurality of beams, each beam being of a different order; and
(d) shaping the re-split light with an optical shaping device, the shaped beams being allowed to propagate to the substrate to produce an interference pattern upon the substrate.

16. The method as claimed in claim 15, further comprising:
(e) relatively translating the substrate with respect to the interference pattern after patterning a well-defined area of the substrate; and
(f) repeating steps (a) through (d) to expose another area of the substrate to form a well-defined periodic pattern thereupon.

17. The method as claimed in claim 15, further comprising:
(e) relatively rotating the substrate with respect to the interference pattern during the execution of steps (a) through (d) to produce concentric circles upon the substrate.

18. The method as claimed in claim 15, further comprising:
(e) relatively translating the substrate with respect to the interference pattern during the execution of steps (a) through (d) to produce a larger area having a well-defined periodic pattern therein.

19. The method as claimed in claim 15, wherein the light is split using transmission diffraction gratings.

20. The method as claimed in claim 15, wherein the light is split using reflection diffraction gratings.

21. The method as claimed in claim 15, wherein the light is split using reflection diffraction gratings and transmission diffraction gratings.

22. The method as claimed in claim 15, further comprising:
(e) shaping the incoherent light with a first optical shaping device prior to the initial splitting of the incoherent light into a plurality of beams.

23. The method as claimed in claim 15, further comprising:
(e) shaping the incoherent light with a first optical shaping device prior to the initial splitting of the light into a plurality of beams; and
(f) shaping the split light beams with a second optical shaping device after to the initial splitting of the light into a plurality of beams.

24. The method as claimed in claim 23, further comprising:
(g) relatively translating the substrate with respect to the interference pattern after patterning a well-defined area of the substrate; and
(h) repeating steps (a) through (f) to expose another area of the substrate to form a well-defined periodic pattern thereupon.

25. The method as claimed in claim 23, further comprising:
(g) relatively rotating the substrate with respect to the interference pattern during the execution of steps (a) through (f) to produce concentric circles upon the substrate.

26. The method as claimed in claim 23, further comprising:
(g) relatively translating the substrate with respect to the interference pattern during the execution of steps (a) through (f) to produce a larger area having a well-defined periodic pattern therein.

27. The method as claimed in claim 23, wherein the light is split using transmission diffraction gratings.

28. The method as claimed in claim 23, wherein the light is split using reflection diffraction gratings.

29. The method as claimed in claim 23, wherein the light is split using reflection diffraction gratings and transmission diffraction gratings.

30. A system for exposing a substrate to form a well-defined periodic pattern thereupon, comprising:
a source of incoherent light;
an optical shaping device to shape the incoherent light;
a first beam splitter to split the shaped light into a plurality of beams, each beam being of a different order; and
a second beam splitter to split the split beams into a plurality of beams, each beam being of a different order, the second beam splitter allowing the re-split beams to propagate to the substrate to produce an interference pattern upon the substrate.

31. The system as claimed in claim 30, further comprising:
means for relatively translating said substrate with respect to the interference pattern after patterning a well-defined area of the substrate to enable the exposure of another area of the substrate to form a well-defined periodic pattern thereupon.

32. The system as claimed in claim 30, further comprising:
means for relatively rotating said substrate with respect to the interference pattern during exposure to produce concentric circles upon the substrate.

33. The system as claimed in claim 30, further comprising:
means for relatively translating said substrate with respect to the interference pattern during exposure to produce a larger area having a well-defined periodic pattern therein.

34. The system as claimed in claim 30, wherein said first and second beam splitters are transmission diffraction gratings.

35. The system as claimed in claim 30, wherein said first and second beam splitters are reflection diffraction gratings.

36. The system as claimed in claim 30, wherein said first beam splitter is a reflection diffraction grating and said second beam splitter is a plurality of diffraction gratings.

37. The system as claimed in claim 30, wherein said optical shaping device is an aperture.

38. A system for exposing a substrate to form a well-defined periodic pattern thereupon, comprising:
a source of incoherent light;
a first beam splitter to split the incoherent light into a plurality of beams, each beam being of a different order;
an optical shaping device to shape the split light; and
a second beam splitter to split the shaped beams into a plurality of beams, each beam being of a different order, the second beam splitter allowing the re-split beams to propagate to the substrate to produce an interference pattern upon the substrate.

39. The system as claimed in claim 38, further comprising:
means for relatively translating said substrate with respect to the interference pattern after patterning a well-defined area of the substrate to enable the exposure of another area of the substrate to form a well-defined periodic pattern thereupon.

40. The system as claimed in claim 38, further comprising:
means for relatively rotating said substrate with respect to the interference pattern during exposure to produce concentric circles upon the substrate.

41. The system as claimed in claim 38, further comprising:
means for relatively translating said substrate with respect to the interference pattern during exposure to produce a larger area having a well-defined periodic pattern therein.

42. The system as claimed in claim 38, wherein said first and second beam splitters are transmission diffraction gratings.

43. The system as claimed in claim 38, wherein said first and second beam splitters are reflection diffraction gratings.

44. The system as claimed in claim 38, wherein said first beam splitter is a reflection or transmission diffraction grating and said second beam splitter is a plurality of diffraction gratings.

45. The system as claimed in claim 38, wherein said optical shaping device is an aperture.

46. A system for exposing a substrate to form a well-defined periodic pattern thereupon, comprising:
a source of incoherent light;
a first beam splitter to split the incoherent light into a plurality of beams, each beam being of a different order;
a second beam splitter to split the split beams into a plurality of beams, each beam being of a different order; and
an optical shaping device to shape the re-split light, the shaped beams being allowed to propagate to the substrate to produce an interference pattern upon the substrate.

47. The system as claimed in claim 46, further comprising:
means for relatively translating said substrate with respect to the interference pattern after patterning a well-defined area of the substrate to enable the exposure of another area of the substrate to form a well-defined periodic pattern thereupon.

48. The system as claimed in claim 46, further comprising:
means for relatively rotating said substrate with respect to the interference pattern during exposure to produce concentric circles upon the substrate.

49. The system as claimed in claim 46, further comprising:
means for relatively translating said substrate with respect to the interference pattern during exposure to produce a larger area having a well-defined periodic pattern therein.

50. The system as claimed in claim 46, wherein said first and second beam splitters are transmission diffraction gratings.

51. The system as claimed in claim 46, wherein said first and second beam splitters are reflection diffraction gratings.

52. The system as claimed in claim 46, wherein said first beam splitter is a reflection or transmission diffraction grating and said second beam splitter is a plurality of diffraction gratings.

53. The system as claimed in claim 46, wherein said optical shaping device is an aperture.

54. The system as claimed in claim 46, further comprising:
a pre-splitter optical shaping device to shape the incoherent light;
said first beam splitter splitting the shaped light into a plurality of beams.

55. The system as claimed in claim 46, further comprising:
a pre-splitter optical shaping device to shape the incoherent light; and
said first beam splitter splitting the shaped light into a plurality of beams;
a second pre-splitter optical shaping device to shape the split light;
said second beam splitter splitting the shaped beams into a plurality of beams.

56. The system as claimed in claim 55, further comprising:
means for relatively translating said substrate with respect to the interference pattern after patterning a well-defined area of the substrate to enable the exposure of another area of the substrate to form a well-defined periodic pattern thereupon.

57. The system as claimed in claim 55, further comprising:
means for relatively rotating said substrate with respect to the interference pattern during exposure to produce concentric circles upon the substrate.

58. The system as claimed in claim 55, further comprising:
means for relatively translating said substrate with respect to the interference pattern during exposure to produce a larger area having a well-defined periodic pattern therein.

59. The system as claimed in claim 55, wherein said first and second beam splitters are transmission diffraction gratings.

60. The system as claimed in claim 55, wherein said first and second beam splitters are reflection diffraction gratings.

61. The system as claimed in claim 55, wherein said first beam splitter is a reflection or transmission diffraction grating and said second beam splitter is a plurality of diffraction gratings.

62. The system as claimed in claim 55, wherein said optical shaping devices are apertures.
